(19) United States
(12) Patent Application Publication
(10) Pub. No.: US 2009/0112830 A1
(43) Pub. Date: Apr. 30, 2009

(54) SYSTEM AND METHODS FOR SEARCHING IMAGES IN PRESENTATIONS

(75) Inventors: Laurent Denoue, Palo Alto, CA (US); John Adcock, Menlo Park, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/924,518

(22) Filed: Oct. 25, 2007

(51) Int. Cl. G06F 17/30

(52) U.S. Cl. 707/4; 707/E17.014

(57) ABSTRACT

Image search and retrieval system is provided. System identifies pictures embedded in presentation slides. System represents each set of identical (or nearly identical) images with unique token. For example, if specific picture is reused in multiple presentations, it will be represented by system using same token. System may compute and store various meta attributes associated with presentation slide and image(s) therein. After the token and meta attribute information are generated for images and/or slides, generated data is provided to text-based search engine. A searched image is subsequently located and retrieved by user using search query issued by user to text-based search engine, which locates images based on generated token and meta attribute information. At query time, user enters search keywords describing target image that user desires to locate. Pursuant to user's query, system retrieves all matching presentation slides. Found images may be ranked using, for example, tf*idf score.

### DESCRIPTION OF THE INVENTION

1. Field of the Invention

The present invention generally relates to information search systems and more specifically to a system for searching images in presentations and other documents.

2. Description of the Related Art

Multimedia presentations, such as PowerPoint presentations, have become the predominant communication medium of the 21st century organization. This communication medium is uniquely visual, frequently containing various visual subject matter, such as pictures and charts. This visual subject matter has a high value for communication and is often reused across presentations within an organization. But, commensurate with their high communicative value, pictures and charts are more expensive to produce than textual information in terms of time and skills required. Because of this, reusing pictures is especially important. In addition, because presentation slides may not contain large amounts of text, in most cases, it is not effective to rely on the text search alone to retrieve existing slides for research or re-use. Finally, because slides are highly visual in nature, users will be likely to identify previously seen information according to the pictures they saw earlier.

While there exist various image search engines, such engines generally rely on filenames, anchor text and text surrounding the image to perform image search and retrieval. However, the existing image search engines generally do not provide functionality for ranking the images and the documents containing those images, which is necessary to enable the user to effectively locate the necessary information. For example, the LADI image search and retrieval system, well known to persons of skill in the art, shows page thumbnails of documents that are retrieved by the Google Desktop search engine. However, the images in the aforesaid LADI system represent previews for the entire page, and not for individual pictures that could be found in these pages, which does not enable the finding and retrieval of individual images by the user.

Thus, the existing image search and retrieval systems fail to provide functionality necessary to enable a user to effectively search for individual images in presentation slides and to retrieve the found images.

### SUMMARY OF THE INVENTION

The inventive methodology is directed to methods and systems that substantially obviate one or more of the above and other problems associated with conventional techniques for searching images in presentations and other documents.

In accordance with one aspect of the invention, there is provided a method involving: extracting at least one image embedded in at least one presentation slide; generating a token representation of the identified at least one image; computing meta attributes of the identified at least one image and the at least one presentation slide; making the generated token representation and the computed meta attributes available to a search engine; and performing image search using the generated token representation and the computed meta attributes.

In accordance with another aspect of the invention, there is provided a system incorporating: an image extraction module operable to extract at least one image embedded in at least one presentation slide; a token generation module operable to generate a token representation of the identified at least one image; a meta attributes computing module operable to compute meta attributes of the identified at least one image and the at least one presentation slide; and a search engine operable to access the generated token representation and the computed meta attributes and perform image search using the generated token representation and the computed meta attributes.

A computer-readable medium embodying a set of computer instructions implementing a method involving: extracting at least one image embedded in at least one presentation slide; generating a token representation of the identified at least one image; computing meta attributes of the identified at least one image and the at least one presentation slide; making the generated token representation and the computed meta attributes available to a search engine; and performing image search using the generated token representation and the computed meta attributes.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of an operating sequence of the inventive image search and retrieval system.

FIG. 2 illustrates another exemplary embodiment of an operating sequence of the inventive image search and retrieval system.

FIG. 3 illustrates an exemplary embodiment of the user interface of the inventive image search and retrieval system.

FIG. 4 illustrates similar background template of a sequence of presentation slides.

FIG. 5 illustrates an operating sequence of an exemplary embodiment of the inventive methodology.

FIG. 6 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

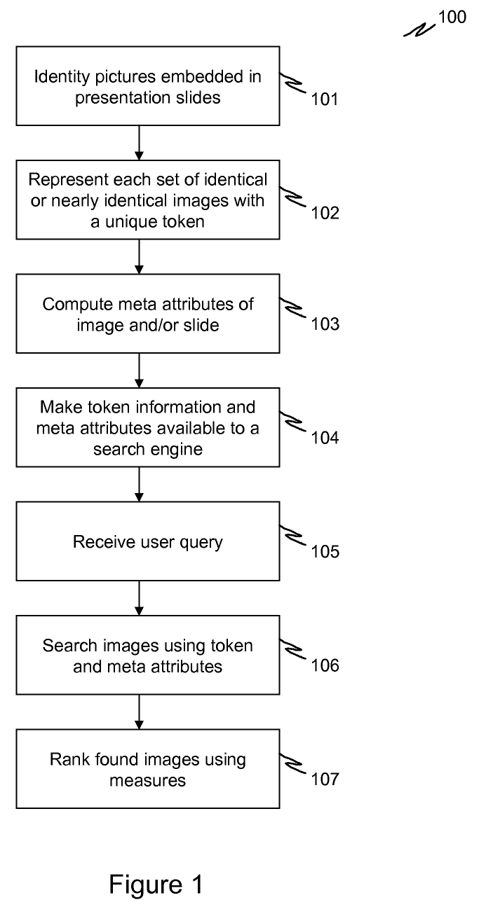

To address the aforesaid need for locating and retrieving images used in visual presentations, the inventive image search and retrieval system is provided. An exemplary embodiment of the operating sequence 100 of the inventive image search and retrieval system is illustrated in FIG. 1. First, at step 101, an embodiment of the inventive image search and retrieval system identifies pictures embedded in presentation slides. Various embodiments of the inventive image search and retrieval system may perform the aforesaid image identification using various types of presentation slides, including unstructured images of slides captured by an automatic meeting capture system, such as Pbox, or images that are extracted from a structured digital presentation document, such as the PowerPoint presentation file, containing the visual presentation slides. The aforesaid Pbox and PowerPoint systems are well known to persons of ordinary skill in the art. While presentation documents are the motivating example, the described invention is equally applicable to other documents containing both text and images. In what follows the terms presentation and slide can be considered equivalent to document and page.

Secondly, at step 102, an embodiment of the inventive image search and retrieval system represents each set of identical (or nearly identical) images with a unique token. For example, if a specific picture is reused in two different presentations, it will be represented by the inventive system using the same token. In an embodiment of the inventive system, the aforesaid token representing one or more identical images is inserted in the full-text representation of the slide, as if it was a word in the slide. Thus, the subsequent image search and retrieval can benefit from all the capabilities of the underlying text indexing and search system, which is now applied to image search.

In addition, an embodiment of the inventive image search and retrieval system may compute and store various meta attributes associated with the presentation slide and the image(s) and text therein, such as the position of the image(s) and text elements on the slide, the width and height of the image(s) and text elements, the image size relative to the size of the entire slide, the number of images on that slide, as well as the date/time when this slide was captured, see FIG. 1, step 103. As would be appreciated by those of skill in the art, the meta attributes computed by the inventive image search and retrieval system are not limited to the enumerated meta attributes and other suitable image or slide attributes may be similarly determined and stored.

After the aforesaid token and meta attribute information are generated for the images and/or text and slides, at step 104, the generated data is provided to, or is otherwise made available to a text-based search engine, such as Google desktop and the widely used Lucene open source information retrieval library. The aforesaid Google desktop and the aforesaid Lucene open source information retrieval library are well known to persons of ordinary skill in art. A searched image is subsequently located and retrieved by a user using a search query issued by the user at step 105 to the aforesaid text-based search engine, which is operable to locate the images based on the generated token and meta attribute information, see step 106.

At the query time, the user enters one or more search keywords describing the target image that the user desires to locate. Pursuant to the user query, an embodiment of the inventive system retrieves all presentation slides that, for example, contain the specified keyword, see step 106. In an embodiment of the inventive methodology, the inventive search and retrieval system displays only the images contained in the slides, showing only one exemplar of each set of duplicate images. As stated above, duplicate images map to the same unique token identifier. In an embodiment of the inventive technique, the inventive image search and retrieval system ranks the images using, for example, variants of term-frequency inverse-document-frequency (tf*idf) measures used in traditional text information retrieval, see step 107. The tf*idf measure is positively related to the number of times a term appears in a document or relevant subset of documents but is inversely related to the frequency of the term in the overall corpus. The aforesaid image ranking using the tf*idf score is well known to persons of skill in the art and will be described in detail below. It should be noted that the inventive system is capable of using the aforesaid image ranking using the tf*idf measures because each image is represented as a token, just as normal keywords in text retrieval.

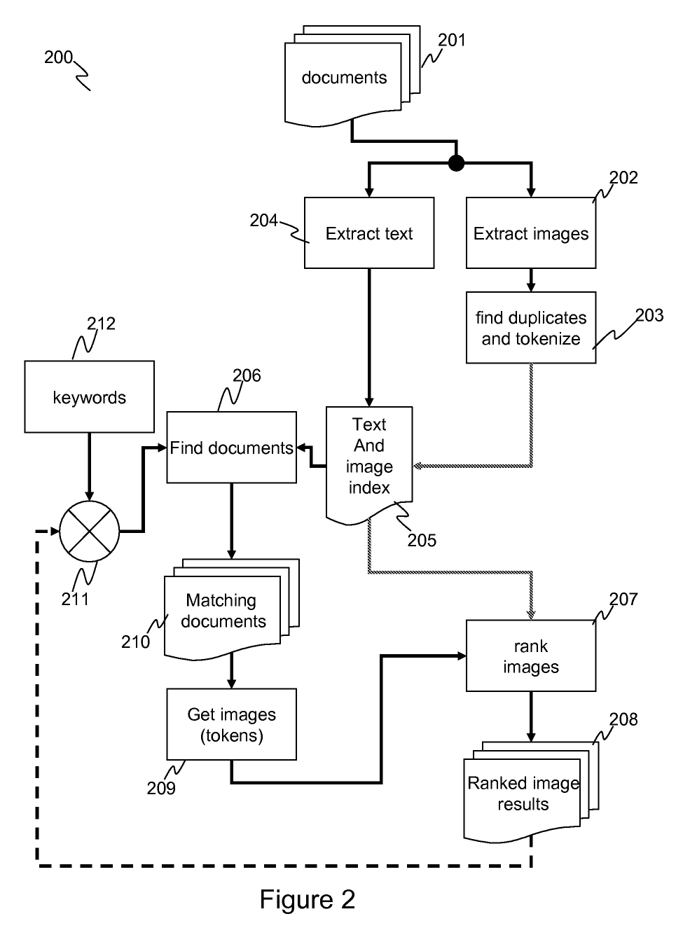

FIG. 2 illustrates another exemplary operating sequence 200 of an embodiment of the inventive techniques. At step 201, the documents, such as presentations, containing both the images and the accompanying text are provided. At step 202 an embodiment of the inventive system extracts the images from the documents. At step 203, the duplicate images are found and removed and token representations of the images are created as described below. The image token data is incorporated into the index at step 205 along with the image metadata. At step 204, an embodiment of the inventive system also extracts from the documents the text accompanying the images. The extracted text and associated metadata is also incorporated into the index at step 205. The text and image index, 205, maintains the record of occurrences of text and image tokens in the document corpus, along with the context of each occurrence is described by the associated metadata. At query time, the user provides keywords, see step 212, which are used, in conjunction with the text index computed in step 205 to find a set of matching documents, see step 206. The matching documents are returned at step 210 and the image tokens, associated with the matching documents, are retrieved in step 209. The retrieved images identified by the aforesaid image tokens are ranked at step 207 using information from the text and image index built at step 205. Finally, the ranked image results are returned at step 208.

In an exemplary embodiment of the inventive technique, the inventive image search and retrieval system sorts image retrieval results by combining one or more features of the image and/or one or more features of the accompanying slide. Exemplary image and/or slide features may include, without limitation, the tf*idf score of the image; the size of the image relative to the size of the slide; the inverse of the number of images in the slide and the distance of the image to a keyword on the slide that was searched for by the user divided by the diagonal size of the slide.

In computing the aforesaid tf*idf score, the first “tf” portion is positively related to the count of the image occurrences in the search results, while the second “idf” portion is inversely related to the number of occurrences of the image in the overall image corpus. It should be noted that the aforesaid tf*idf is not the only image scoring technique that can be used in ranking the image search results in the inventive image search and retrieval system. Various other well known re-ranking methods can be similarly applied in this context. Examples of such methods are described in Xu, J. and Croft, W. B. “Improving the effectiveness of information retrieval with local context analysis.” ACM Trans. Inf. Syst. 18, 1 (January 2000). Thus, the present invention is not limited to any specific scoring or ranking technique.

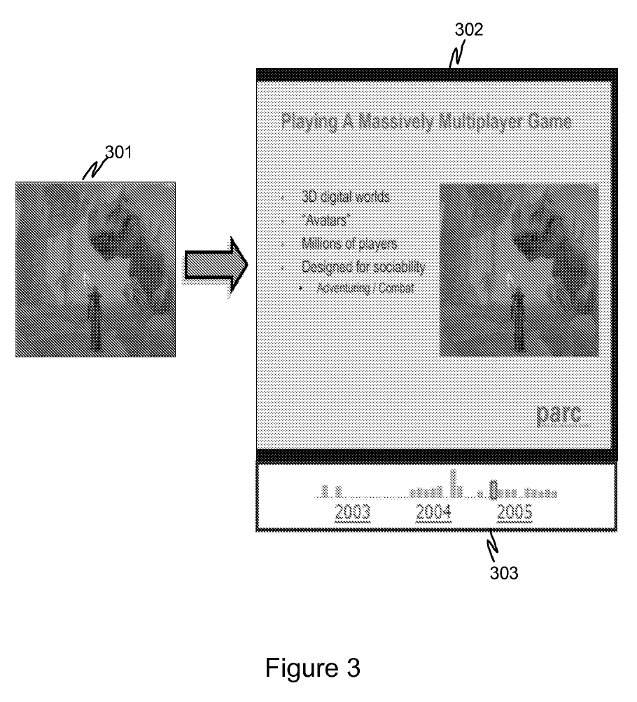

In an exemplary embodiment of the invention, when a user hovers a pointing device over a retrieved image in the image results list, the inventive system shows the user the context slide where the retrieved image was used. For example, the image context may include a slide, multiple slides, a presentation or multiple presentations, which incorporated the retrieved image. Furthermore, an embodiment of the inventive system may provide to a user a histogram, preferably positioned in the immediate vicinity of the slide image, which would provide information indicating when the retrieved image was used, see FIG. 3. In that figure, illustrating an exemplary embodiment of the user interface of the inventive image search and retrieval system, the user is shown context 302 of the image 301 and is also shown a histogram 303 indicating how many times and when the image 301 has been used in presentation(s). In another embodiment, the system would enable the user to quickly browse through all occurrences of the retrieved image in the presentations.

Once the images have been retrieved, the user can select one or more of the retrieved images using the inventive interface and use the selected image(s) to form a new search query or augment an existing search query. This allows the user to continue searching the collection of slides, using image(s) as queries instead of, or in addition to keywords. Because of the tokenization of the images in the corpus, image tokens may act just as text with the search engine. Such searching method is useful when a slide containing an image was not retrieved the first time because it did not contain the requisite keyword, or because the OCR system failed to recognize the word properly. For example, if the user is searching for a “FlyCam”, the inventive system could retrieve a slide that contains the keyword “FlyCam”, along with two pictures. Now, the user can choose to also find slides that contain one or more of the pictures on the retrieved slide, possibly retrieving more relevant slides.

Below, details of specific embodiments of the inventive image search and retrieval system and its various components will be described.

Extracting Pictures from Slide Images

As well known in the art, the presentation slides may be captured using a variety of well-known techniques, such as using the Pbox system described hereinabove. After the capture, the slides are passed to OCR software engine, which extracts textual information from the slides and stores the extracted textual information such that it is available to a text-based search engine. Next, the images are extracted from the slide.

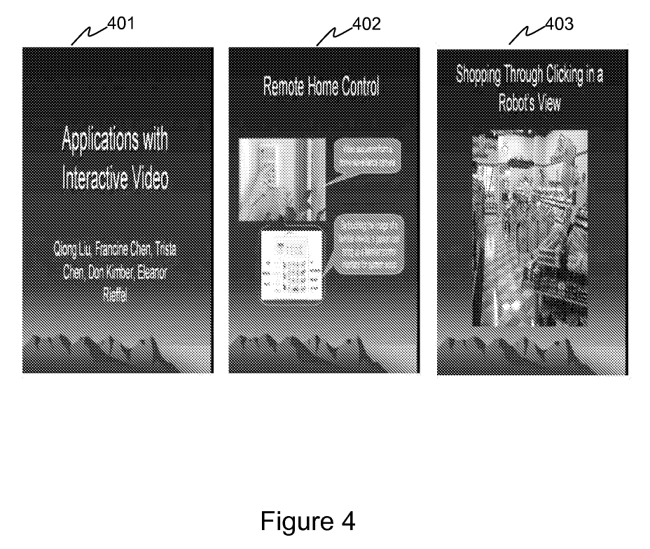

To extract pictures from the captured slide images in 101 of FIG. 1, one embodiment of the inventive system leverages the fact that slides in the same series of slides (even as few as three slides in the same series) usually have the same background image template, as illustrated, for example, in FIG. 4. In that figure, slides 401, 402 and 403 have identical similar background images. By using well-known methods for image and video background estimation, the embodiment of the inventive system eliminates unchanging background areas from consideration in the image extraction process. When available, the embodiment of the inventive system also uses the bounding boxes of the words as found by the aforesaid OCR engine and removes areas containing textual information as possible candidate areas for extracting images. The areas remaining after the aforesaid elimination of the background and the text areas are considered as candidates for extraction of images. To further locate the rectangle enclosing each image, an embodiment of the inventive methodology relies on existing well-known techniques such as Hough transforms and corner detections to identify distinctive rectangular regions. Candidate areas are assessed for sanity before extraction; wherein areas that are too small or have unlikely aspect ratios are eliminated from consideration by the inventive system.

Extracting Pictures from Digital Files

To extract pictures from digital files such as PowerPoint presentations, an embodiment of the inventive methodology leverages the Document Object Model (DOM) of the authoring application, which was used in creating the aforesaid presentation. For example, PowerPoint allows querying its Document Object Model to get the location of various media elements in the presentation. In addition, another embodiment of the inventive technique distills the presentation documents to a predetermined file format, such as PDF file format, and thereafter uses an image conversion utility to create images of the presentation slides using the distilled image in the aforesaid predetermined file format (PDF). An example of such utility is the PDF2IMAGE.EXE tool, which is distributed as a part of the XPDF software package, well known to persons of skill in the art.

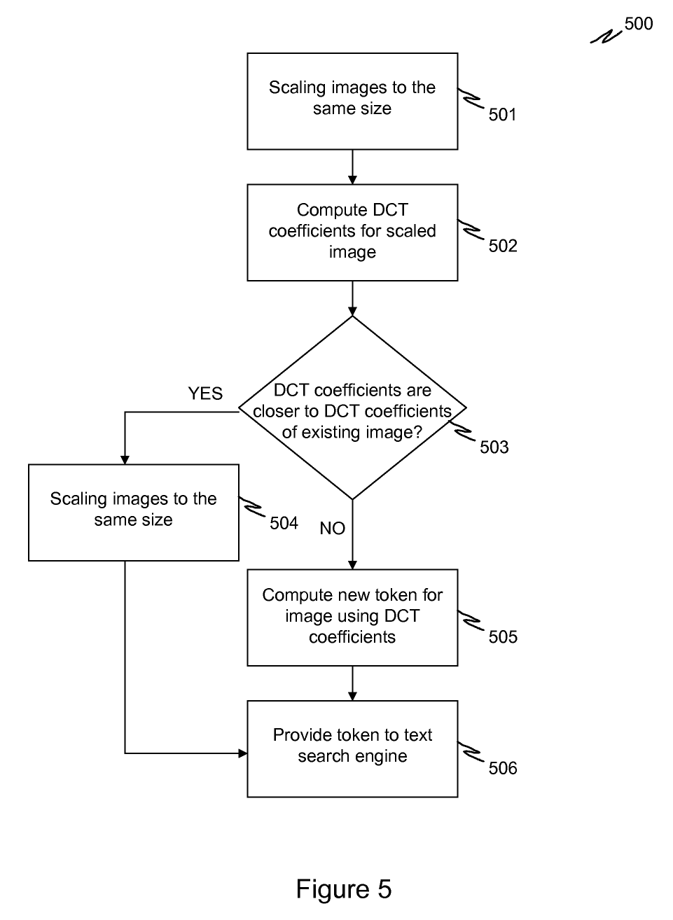

FIG. 5 illustrates an operating sequence 500 of an exemplary embodiment of the inventive methodology, whereby tokens are computed for images obtained from the presentation slides.

### Computing TF-IDF Score for Pictures

For each image extracted in the image extraction step, an embodiment of the inventive technique identifies duplicate versions of the same image within the set of all extracted images and associates a unique discrete identifying token suitable for text indexing with all duplicate versions of an image. In order to perform image comparison, in an embodiment of the inventive image search and retrieval system, each image is scaled to the same size, for example to 128×4128 pixels, see FIG. 5, step 501. After the scaling operation, the image is subjected to Discrete Cosine Transform, wherein the image is transformed from a spatial domain to the frequency domain, see step 502. The DCT yields a set of DCT coefficients that represent the image in the frequency domain. Thereafter, comparison of truncated DCT coefficients of the scaled images is performed at step 503 such that two similar images will be still found similar even though users embedded them at different sizes or even aspect ratios into different slides. If the DCT coefficients are found to be sufficiently close, the images are scaled to the same size at step 504. In one example the DCT coefficients of two images are compared using the widely known cosine distance between their respective vectors of DCT coefficients. Additionally or alternatively, an embodiment of the inventive system may use various well-known methods for duplicate or near-duplicate image identification. It should be noted that the inventive system is not limited to any such specific methods.

Thereafter, each unique image is represented in the text index for the slides on which it occurs by its corresponding unique token, see step 505. This token is unique, distinguishable from regular text, and a valid token for handling by the text indexing system. In an embodiment of the inventive technique the tokenization process may assign indexalbe tokens to images by generating a single unique random prefix consisting of some number of characters and appending the index of the image in the image database. In an embodiment of the inventive technique, the inventive algorithm is incremental: when a new image is detected, it is scaled to a canonical size, its DCT coefficients are computed and if its DCT coefficients are sufficiently close to the coefficients of a previously indexed image the image is associated with the token of the previously indexed image, see step 503. Otherwise, the image is introduced to the image database and associated with a new unique identifying token, see step 505. This feature of an embodiment of the inventive technique allows capture appliances, such as Pbox, to continuously add images to an existing database of images. Thereafter, the token is provided to a text indexing and search engine at step 506.

To compute the actual Term Frequency (tf) and Inverse Document Frequency (idf) values, an embodiment of the inventive technique considers document groupings at several levels of granularity, ranging from presentations (if available), to hours, days, weeks, or months (if slides contain such time information) for determining the body of documents that should be considered when counting overall term frequencies for the corpus. In other words, an embodiment of the inventive system may consider images occurring in the presentations during the aforesaid time periods of hours, days, weeks, or months long. For autonomous recording appliances like Pbox, a month appears to be a reasonable level of granularity for determining a group of slides over which to compute term frequency statistics. But the aforesaid appropriate levels of granularity can be suitably computed, even at query-time and need not necessarily be hard-coded in the system.

Traditional web-based image search engines rely primarily on the filename of the image as well as the html ALT content associated with html IMG tag to associate keywords with images for retrieval of images through text search. In the scenario described herein, this information is not available since the documents are not assumed to be so structured. Instead, an embodiment of the inventive system uses image size, the size of the image relative to the size of the slide, the number of images also present in the slide, and the distance within the captured slide or document of the image to the keyword that was searched for by the user to compute the similarity of a text query to the image. Specifically, the similarity of an image to a query word is: greater for words that are more closely positioned to the image within the document, greater for images that are larger, and greater for images that appear with fewer other images. In one embodiment of the inventive technique, the aforesaid measures are combined along with the tf*idf measure described above based on frequency of occurrence, into an overall image score by simple multiplication or summation, after which the aforesaid overall score is used to sort individual images in the image query results. In another embodiment, the overall image score is computed by combining the aforesaid similarity measures by summing them using possibly unequal weightings for different measures. For instance, the significance of the closeness of the matched word to the image may be considered most important in some scenarios and receive a dominant weight compare to the weights of the other measures. As would be appreciate by those of skill in the art, the latter technique provides more flexibility in appropriately tuning the ranking of the image search results. The aforesaid weight parameters may be selected or tuned using experimentation. The best performing set of weights may vary depending on the characteristics of the presentations or documents under consideration. That is to say, that different corpora created in different contexts by different groups of authors with different habits for composition may result in different optimal weights. In one setting the closeness of text terms to the image may be most important for ranking retrieved images. In another setting the size of the image may be most important. It should be apparent to those of skill in the art that the weights of different ranking factors can be adjusted to tune performance in differing settings.

Now, various exemplary application scenarios of embodiments of the inventive image search and retrieval system will be described.

Finding a Picture of ePaper

A researcher from Japan gave a talk about ePaper, and a user remembered seeing a picture that explained its mechanism. The user desirous to locate the aforesaid image, issues a query to the inventive image search and retrieval system. The issued query includes a term “epaper”. Instead of having the user go through all slide images that might or might not contain images of epaper, the inventive system gives the user a concise view of all images that have been embedded in slides discussing “epaper”. When a user scrolls a mouse over one result, the system shows the user the actual slide where that picture was embedded as shown in FIG. 2.

If the user still does not find the one image that the user has been looking for, the user can ask the inventive system to show related slides, which include slides that also contain images previously retrieved but not necessarily with the keyword “epaper” that the user has been originally looking for.

### Application Scenarios: Finding Related Pictures

Having found the picture the user has been looking for, the user is now authoring a new presentation that talks about the same topic. But the user wants to find images that are related to the one he previously found. He can submit the image as a query to the system, which will retrieve all pictures that were embedded in presentations where the query picture was found. Quickly generating an overview of all pictures related to this project.

### Application Scenarios: Managing User's Media Assets

A user is about to give a presentation to a group of people. As the user embeds pictures into the new presentation, the user can quickly check if these same pictures have already been used a lot or not by using the images as a query to search the archive of previously created presentations. By examining the results, in particular the histogram of image occurrences as illustrated in FIG. 2, the user may quickly decide if the his visuals will be perceived as old or not.

### Exemplary Computer Platform

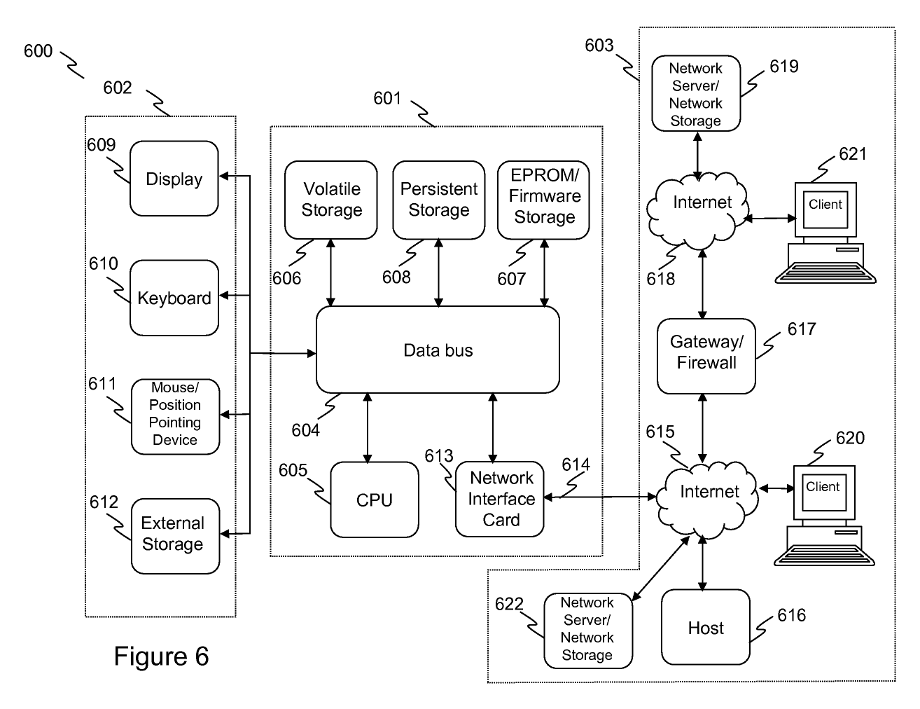

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be connected to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is connected to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized image search and retrieval system. It is intended that the specification and examples be considered as exemplary only, with a true scope and spirit of the invention being indicated by the following claims.

What is claimed is:

1. A method comprising:
a. Extracting at least one image embedded in at least one presentation slide;
b. Generating a token representation of the identified at least one image;
c. Computing meta attributes of the identified at least one image and the at least one presentation slide;
d. Making the generated token representation and the computed meta attributes available to a search engine; and
e. Performing image search using the generated token representation and the computed meta attributes.

2. The method of claim 1, further comprising ranking found images using at least one measure.

3. The method of claim 2, wherein the at least one measure is a tf*idf measure.

4. The method of claim 1, wherein generating the token presentation further comprises:
i. Scaling the image to a predetermined size;
ii. Performing transformation of the scaled image into a frequency domain to create a frequency representation of the image; and
iii. Finding duplicate images, wherein finding duplicate images comprises generating the token representation of the image using the frequency representation of the image and comparing frequency representation coefficients of the image to second frequency representation coefficients of a second image and, if the frequency representation coefficients are close to the second frequency representation coefficients, using second token representation of the second image as the token representation.

5. The method of claim 1, further comprising extracting textual information from the at least one presentation slide and making the extracted textual information available to the search engine.

6. The method of claim 5, wherein the textual information is extracted using an optical character recognition.

7. The method of claim 1, wherein similar images have identical token representations.

8. The method of claim 1, wherein computing meta attributes comprises:
determining position of the one or more images on the at least one presentation slide, determining width and height of the one or more images, determining a size of the one or more images relative to a size of the at least one presentation slide or determining a number of images in the at least one presentation slide.

9. The method of claim 1, further comprising displaying found images and removing duplicate images.

10. The method of claim 9, further comprising displaying information on previous uses of the found images.

11. The method of claim 9, further comprising enabling a user to select at least one found image and use the selected at least one found image to form a new search query or augment an existing search query.

12. The method of claim 1, wherein extracting at least one image comprises eliminating background of the at least one presentation slide.

13. A system comprising:
a. Image extraction module operable to extract at least one image embedded in at least one presentation slide;
b. Token generation module operable to generate a token representation of the identified at least one image;
c. Meta attributes computing module operable to compute meta attributes of the identified at least one image and the at least one presentation slide;
d. A search engine operable to access the generated token representation and the computed meta attributes and perform image search using the generated token representation and the computed meta attributes.

14. The system of claim 13, wherein the search engine is further operable to rank found images using at least one measure.

15. The system of claim 14, wherein the at least one measure is a tf*idf measure.

16. The system of claim 13, wherein the token generation module is further operable to:
i. Scale the image to a predetermined size;
ii. Perform transformation of the scaled image into a frequency domain to create a frequency representation of the image; and
iii. Find duplicate images, wherein finding duplicate images comprises generating the token representation of the image using the frequency representation of the image and comparing frequency representation coefficients of the image to second frequency representation coefficients of a second image and, if the frequency representation coefficients are close to the second frequency representation coefficients, using second token representation of the second image as the token representation.

17. The system of claim 13, further comprising a textual information extraction module operable to extract textual information from the at least one presentation slide and make the extracted textual information available to the search engine.

18. The system of claim 17, wherein the textual information is extracted using an optical character recognition.

19. The system of claim 13, wherein similar images have identical token representations.

20. The system of claim 13, wherein meta attributes computing module is further operable to: determine position of the one or more images on the at least one presentation slide, determine width and height of the one or more images, determine a size of the one or more images relative to a size of the at least one presentation slide or determine a number of images in the at least one presentation slide.

21. The system of claim 13, further comprising a used interface operable to display found images and remove duplicate images.

22. The system of claim 21, wherein the user interface is further operable to display information on previous uses of the found images.

23. The system of claim 21, wherein the user interface is further operable to enable a user to select at least one found image and use the selected at least one found image to form a new search query or augment an existing search query.

24. The system of claim 13, wherein the image extraction module is further operable to eliminate background of the at least one presentation slide.

25. A computer-readable medium embodying a set of computer instructions implementing a method comprising:
a. Extracting at least one image embedded in at least one presentation slide;
b. Generating a token representation of the identified at least one image;
c. Computing meta attributes of the identified at least one image and the at least one presentation slide;
d. Making the generated token representation and the computed meta attributes available to a search engine; and
e. Performing image search using the generated token representation and the computed meta attributes.
